(19) United States
(12) Patent Application Publication
(10) Pub. No.: US 2024/0119854 A1
(43) Pub. Date: Apr. 11, 2024

(54) Method for Automatically Converting a Text string to an Interactive Video Experience

(71) Applicant: Allego, Inc., Waltham, MA (US)

(72) Inventors: Andre B. Black, Waltham, MA (US); Edward Chin, Waltham, MA (US); Yuchun Lee, Waltham, MA (US); Quan Do, Waltham, MA (US)

(21) Appl. No.: 18/480,574

(22) Filed: Oct. 4, 2023

Related U.S. Application Data
(60) Provisional application No. 63/414,976, filed on Oct. 11, 2022.

(51) Int. Cl. G09B 5/06; G06T 13/00; G10L 15/22; G10L 15/26; G10L 15/30

(52) U.S. Cl. CPC G09B 5/065; G06T 13/00; G10L 15/22; G10L 15/26; G10L 15/30; G06T 2200/24

(57) ABSTRACT

Computer implemented techniques for converting a text string to an interactive media. The techniques cause a data processing system to receive a text string having one or more branching moments, process the text string to recognize indications of the one or more branching moments given the text string, convert the processed text string and the indications of the one or more branching moments into executable computer code, receive a response to a given one of the converted one or more branching moments from a predetermined set of responses, generate, from the executable computer code and media elements for the response, a virtual respondent, and store the executable computer code and the media elements as a file in the computer storage that represents the virtual respondent.

### CROSS-REFERENCE TO RELATED APPLICATION

This application claims the benefit of U.S. Provisional Application No. 63/414,976, filed Oct. 11, 2022, the contents of which are incorporated by reference herein.

### BACKGROUND

This invention relates to computer implemented training methodologies.

Geographically-distributed employees that have responsibilities that include face-to-face or live telephone-based customer interactions often may be challenged in consistently delivering approved corporate messaging with polished delivery that is appropriate and compelling for their customers. Many corporate training programs involve intensive “boot camp” type of engagements, i.e., typical practices such as geographically-distributed employees, e.g., a sales force travel to a common geographical location that is out of the sales field and where these employees are isolated for intensive training. Typically, these boot camp type training programs run for a finite time, conclude, and are often not repeated at least for the same topic under the assumption which may not be fully verified that the person has absorbed the information.

One use case involves interactive role play, where a computer simulates a virtual actor and a user carries on a conversation with the virtual actor. Prior techniques are resource intensive, e.g., computationally resource intensive, especially when there may be branching moments in the conversation.

### SUMMARY

According to an aspect of the invention, a computer-implemented method includes receiving, by a computer, a text string having one or more branching moments, with the computer including a processor, memory, a non-transitory computer storage, and input/output devices, processing by the computer the text string to recognize indications of the one or more branching moments given the text string, converting, by the computer, the processed text string and the indications of the one or more branching moments into executable computer code, receiving, by the computer, a response to a given one of the converted one or more branching moments from a predetermined set of responses, generating, by the computer from the executable computer code and media elements for the response, a virtual respondent, and storing, by the computer, the executable computer code and the media elements as a file in the computer storage that represents the virtual respondent.

Other aspects include a data processing system and a computer program product tangibly storing a computer program on a non-transitory computer readable medium.

The following are some of the embodiments, amongst others disclosed herein, within the scope of one or more of the above aspects.

Execute the executable computer code to render the response to the text string at the one or more branching moments into computer generated audio, and sending the computer generated audio to a client device to cause the client device to present the computer generated audio at the one or more branching moments. Generate from the executable computer code and the media elements, a virtual actor and cause the virtual actor to render a selected response. Pause video of the virtual respondent, cause choice buttons, for the given one of the converted one or more branching moments, to be rendered in juxtaposition to the paused video of the virtual respondent, and receiving input indicating selection of one of the choice buttons which selection indicates the response. Generate a series of text only written responses and cause the series of text only written responses to be rendered for a selected response. Receive an audio signal encoding speech from a participant operating a client device and convert the received audio signal into the text string. The client device can be a separate device from the computer. Processing the text string to recognize indications of the one or more branching moments given the text string can include detecting, in the text string, the one or more branching moments. Converting the processed text string can include converting the processed text string and the indications of the one or more branching moments into JavaScript Object Notation (JSON). Generating, using the JSON and the media elements, the virtual respondent can include generating one or more files that reference the JSON and the media elements.

One or more of the following advantages may be provided by one or more of the above aspects.

One or more of the above aspects provides a user with a self-coaching training experience that can be checked by a user's manager, etc. By depicting a virtual respondent in a video with the human user in juxtaposition the user can be practicing his presentation. The virtual respondent is a computer generated video of a virtual actor that provides responses to the user's narrative in the form of a computer generated narrative of the virtual actor. Alternatively, the virtual respondent can be depicted only as text-based speech bubbles that show responses to the user's narrative, but without the computer generated actor video or audio. The computer generated narrative has branching moments that allow the conversation to branch in different directions depending on the selections made by the user. Other variations are possible.

In some implementations, the systems and methods described in this specification can improve over other systems, e.g., existing computer implemented training systems. For instance, the systems and methods described in this specification can reduce computational resource usage, e.g., by converting the processed text string and the indications of the one or more branching moments into executable computer code, generating or storing data for the virtual respondent, or a combination of both. In some implementations, the systems and methods described in this specification can enable automation for training that was not previously available, e.g., using executable code for branching moments. For instance, processing a text string to recognize indications of the one or more branching moments given the text string, converting a text string and indications of the one or more branching moments into executable computer code, or both, can enable automation that was previously unavailable.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of a networked system executing software for recognizing and converting branching moments in a text string into interactive videos.

FIG. 2 is a flow chart of processing for recognizing branching moments.

FIGS. 3-5 are flow charts of processes for generating the interactive videos.

FIGS. 6-9 are diagrams of screenshots of graphical user interfaces representing segments of an interactive video.

FIG. 10 is a block diagram of a data processing system.

### DETAILED DESCRIPTION

Described below is an integrated information and communication platform that enables devices to produce video in part from parsing a text string that is uploaded to a server/database. In the platform 10, a text string includes text messages, etc.

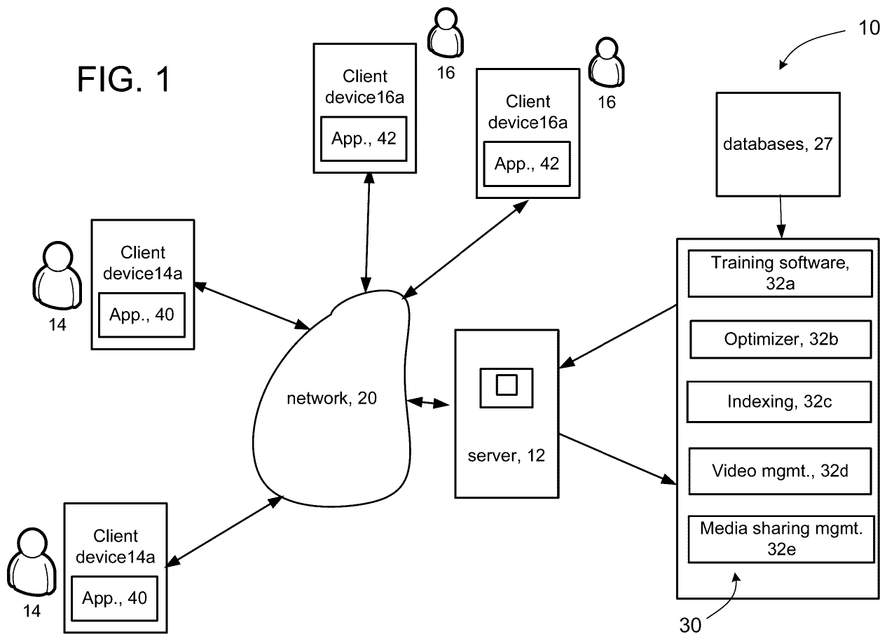

Referring now to FIG. 1, an exemplary networked computer platform 10 “platform 10” that includes functionality for executing training software for converting a text string into an interactive video is shown. The platform 10 includes a computer server system (server) 12 for processing of one or more text strings sent from users 14 by client devices 14a. The text strings are processed and stored in a database, via server 12 that can be accessed by individuals, such a managers 16, via client devices 16a. The server 12 includes an application or a web browser acting as a client utilizing an instance of a hosted application on a web server.

Client devices 14a and 16a can be any combination of, e.g., personal digital assistants, cell phones, computer systems, media-player-type devices, tablet computers and so forth. The client devices 14a enable the users 14 to input and receive information as well as to upload video and audio and/or text to the server 12 for use by the managers 16 (and/or other users). The platform 10 also includes a database 27 containing configuration settings, information, and media, such as the text string.

In some embodiments, the platform 10 is implemented in a cloud-based environment for long-term storage and management of captured media and servers in the cloud have instances of the management software 30 execute on those servers 12 to analyze the captured media to generate useful metadata and previews to allow users to find specific media, and distinguish specific media from other similar media easily and reliably.

A network-capable portable computer system (such as a tablet device) includes an application for executing process 40 for employee practice and performance improvement. Alternatively, computer systems may utilize web browsing software to act as a client that utilizes an instance of a hosted version of the same/similar application functionality. Many such instances of these applications are used to interface with networked databases 27 that store information and media for the applications.

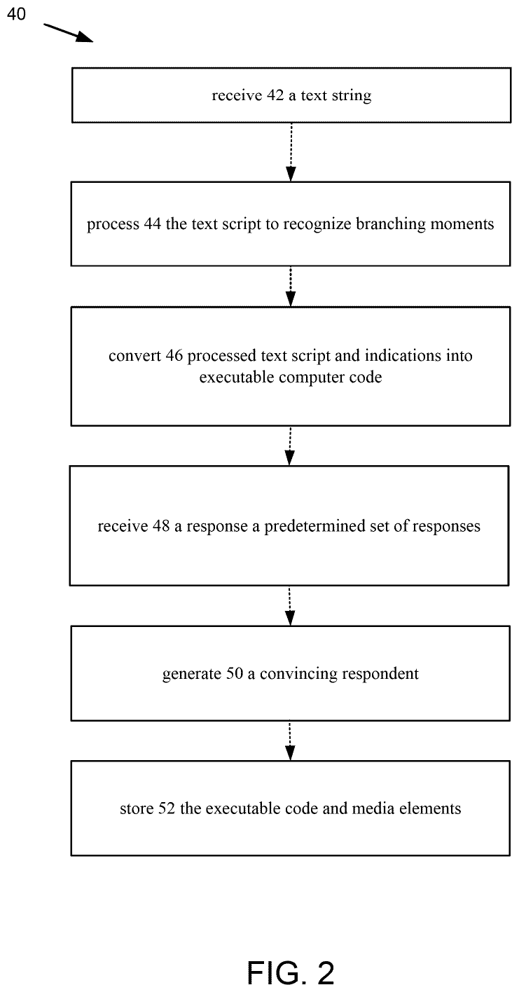

Referring now the FIG. 2, the server 12 executes a process 40 that receives 42 a text string and processes 44 the received text string. The received text string has one or more branching moments to recognize indications of the one or more branching moments. Branching moments are defined as pauses in a conversation where one party should or can react or respond to something that was said by the other participant(s) and the choice of the response could take the conversation in different directions. For instance, the received text string can represent a statement made by a participant operating a client device, e.g., a phrase spoken by the participant.

The process 40 converts 46 the processed text string and the indications of the one or more branching moments into executable computer code (executable computer instructions). The server 12 receives, e.g., selects, 48 a response to the given one of the converted one or more branching moments from a predetermined set of responses. The server 12 generates 50 from the executable computer code and media elements a convincing, virtual respondent “virtual respondent,” and stores 52 the executable computer code and media elements as a file in the computer storage.

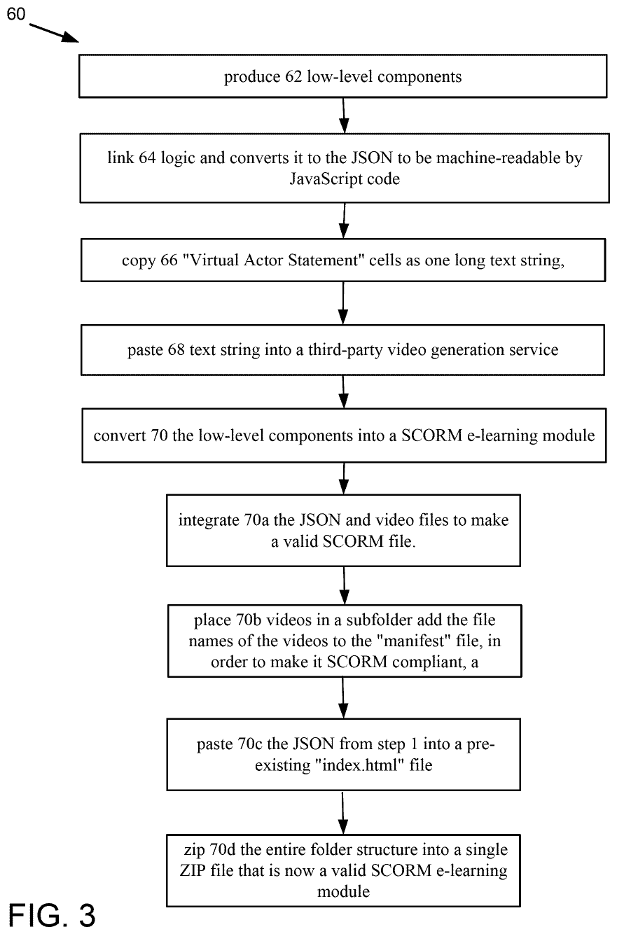

Referring now to FIG. 3, process 60 is shown. Process 60 produces 62 low-level components, e.g., JSON (JavaScript Object Notation), media elements, or both. A template links 64 at least some of logic, e.g., on tab 2 of a spreadsheet. The logic can be a script in the spreadsheet. The template converts the logic to the JSON (JavaScript Object Notation) language so that it will be machine-readable by JavaScript code. Separately, the process captures 66 the text, e.g., from all cells from tab 1, column B, “Virtual Actor Statement” in the spreadsheet, and processes it with a video generation service, e.g., to generate one or more media elements. Either a human intervention or an automated process can be used to capture and process the text Virtual Actor Statements to generate the media elements such as videos. The result is a series of videos, each named for the “Step Number” in tab 1, column A, e.g., in the spreadsheet. Either a human intervention or an automated process can be used to name the videos.

Process 60 next converts 70 the low-level components into a SCORM (Sharable Content Object Reference Model) e-learning module. SCORM is a collection of standards and specifications for web-based electronic educational technology (also called e-learning). SCORM defines communications between client-side content and a host system (called “the run-time environment”), which is commonly supported by a learning management system. SCORM also defines how content may be packaged into a transferable ZIP file called “Package Interchange Format.” (See en.wikipedia.org/wiki/Sharable_Content_Object_Reference_Modelen.wikipedia.org/wiki/Sharable_Content_Object_Reference_Model for more information.)

Process 60 has a pre-produced folder structure, produced by copying a standard set of folders and files. Process 60 integrates 72 the JSON and video files, in order to make a valid SCORM file. Process 60 places 74 the videos in a subfolder within that structure, and adds the file names of the videos to the “manifest” file, in order to make it SCORM compliant, and pastes 76 the JSON from step 1 into a pre-existing “index.html” file that contains the logic to interpret JSON and present it as the interactive adaptive conversational experience for the “virtual respondent,” as a computer generated video of a virtual actor. (Code snippets appear below.) Process 60 zips 78 the entire folder structure into a single ZIP file that is now a valid SCORM e-learning module.

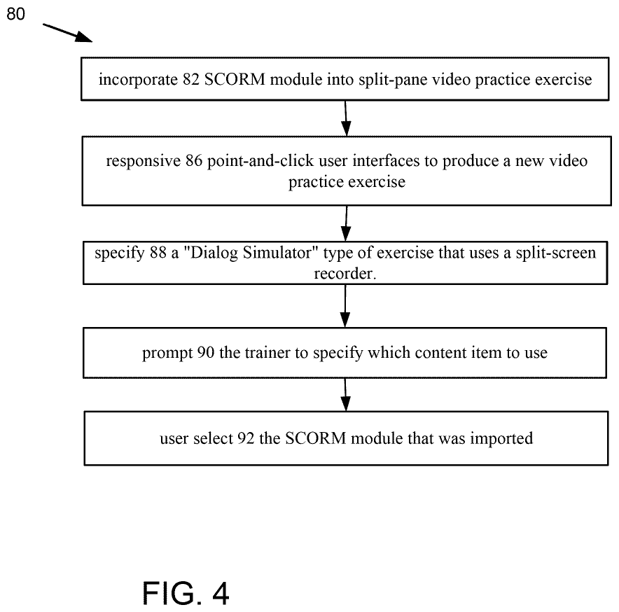

Referring now to FIG. 4, process 80 is shown. Process 80 incorporates 82 the SCORM e-learning module into a split-pane video practice exercise, native to the platform 10. Inside the platform 10, process 80 imports 84 the SCORM file, which provides the imported SCORM file as a platform content item and generates a unique Content ID etc. In the platform 10, process 80 is responsive 86 to point-and-click user type interfaces to produce a new video practice exercise. Process 80 specifies 88 a “Dialog Simulator” type of exercise that uses a split-screen recorder. Process 80 prompts 90 the trainer to specify which content item to use for the left side, for which the user selects 92 the SCORM e-learning module that was imported. The video practice exercise can then be assigned to specific learners or incorporated into courses and curriculums for assigning to waves of learners.

The code samples below are relevant to the SCORM e-learning module, i.e., the process that was described in the prior paragraph.

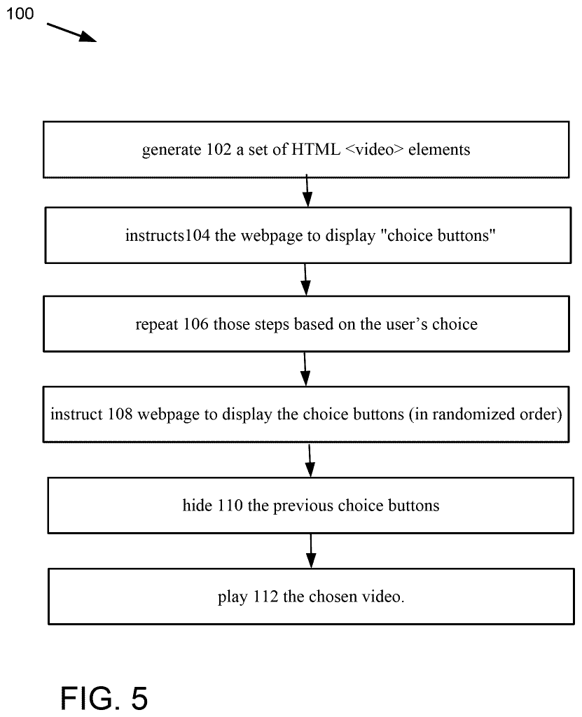

Referring now to FIG. 5, a process 100 that uses the JavaScript, CSS, and HTML code within index.html to generate 102 a set of HTML <video> elements that instruct a web browser to display each of the virtual actor statements in the right sequence in reaction to choices made by the human participant, e.g., which choices can represent selection of a branching moment from multiple branching moments. All video elements are made invisible by default, and paused at their beginnings. The JavaScript and CSS (Cascading Style Sheets) code makes the very first video, for step 1 in the template, visible, but not yet playing, and displays a “Begin” button atop of the first video. (CSS is a style sheet language used for describing a presentation of a document written in a markup language such as HTML or XML (including XML dialects such as SVG, MathML or XHTML). (See en.wikipedia.org/wiki/CSS.)

Once the user clicks “Begin”, the process 100 instructs 104 the webpage to display “choice buttons” (indications of branching moments) for the first step in the conversation at the end of playback, hide the “begin button” and start playing the first video. When video playback ends, the choice buttons (indicated branching moments) are shown to the user. The user can only click one of the choices at any given step in the conversation. That choice determines which video the platform 10 will play next. The process 100 repeats 106 those steps based on the user's choice. The process instructs 108 the webpage to display the choice buttons (in randomized order) for the selected step in the conversation at the end of playback, hide 110 the previous choice buttons, and start playing 112 the chosen video. The process 100 can repeat the instruct webpage step 104 until the user reaches a conversation step that offers only one choice, “End.” At that point, the process 100 displays a message indicating the end of the conversation.

All of that is achieved with the following pseudo code inside the index.html file.

```
            <head>
            <script type=“text/javascript”>
            var data = {
            our pasted JSON script
};
var sCurrentID = “”;
var oChoiceDisplayTimer;
function generateHTML( ) {
  var sHTML = “”;
  for (var key in data) {
    var oStep = data[key];
    sHTML += “\
  <video id=\“main_video_” + oStep.stepid + “\” playsinline=\“\”
style=\“width:100%; height:100%;\”>\
        <source src=\“assets/Clip_” + oStep.stepid + “.mp4\” type=\“video/mp4\”>\
    </video>\
      ”,
  }
  document.getElementById(‘avatar_video_container’).innerHTML = sHTML;
  document.getElementById(“button_choices”).innerHTML = “\
        <a href=\“#\” onclick=\“document.getElementById(‘main_video_’ +
sCurrentID).play( ); hidePreviousChoices( ); return false;\”
role=\“button\”>Begin</a>\
    ”;
}
function displayStepById(sID) { // sID is of the form “6.2”
  var bPlayAtEnd = false;
  if (sCurrentID!=“”) {
    bPlayAtEnd = true;
    var sLastVideoID = “main_video_” + sCurrentID;
    var oOldVideo = document.getElementById(sLastVideoID);
    oOldVideo.pause( );
    oOldVideo.classList.remove(“active-avatar-video”);
    try { oOldVideo.removeEventListener(“ended”,
displayChoicesAtPlaybackEnd); } catch(err) { }
  }
  sCurrentID = data[“step_” + sID].stepid;
  var sNewVideoID = “main_video_” + sCurrentID;
  var oNewVideo = document.getElementById(sNewVideoID);
  oNewVideo.currentTime = 0;
  oNewVideo.classList.add(“active-avatar-video”);
  oNewVideo.addEventListener(‘ended’,displayChoicesAtPlaybackEnd,false);
  if (bPlayAtEnd===true) oNewVideo.play( );
}
function hidePreviousChoices( ) {
  document.getElementById(“button_choices”).innerHTML = “”;
}
function displayChoicesAtPlaybackEnd( ) {
  var sChoiceHTML = “”;
  var oCurrentStep = data[“step_”+sCurrentID];
  if (oCurrentStep[“choice1”][“Go toid”] != “−1”) {
    try { clearTimeout(oChoiceDisplayTimer); } catch(err) { }
    oChoiceDisplayTimer = setTimeout(
      function( ) {
        var sChoiceHTML = “”;
        for (var key in oCurrentStep) {
          if (oCurrentStep[key][“caption”]) { // this is one of the choices
            if (Math.random( ) < 0.5) { // randomize choice order
              sChoiceHTML += “\
                  <a href=\“#\” onclick=\“displayStepById(” + oCurrentStep[key][“Go
toid”] + “); hidePreviousChoices( ); return false;\” role=\“button\”>“ +
oCurrentStep[key][“caption”] + “</a>\
                ”;
            } else {
              sChoiceHTML = “\
                  <a href=\“#\” onclick=\“displayStepById(” + oCurrentStep[key][“Go
toid”] + “); hidePreviousChoices( ); return false;\“ role=\“button\”>“ +
oCurrentStep[key][”caption”] + “</a>\
                ” + sChoiceHTML;
            } // if
          } // if
        } // for
        document.getElementById(“button_choices”).innerHTML = sChoiceHTML;
      },30); // function inside setTimeout
  } else {
    var oBannerMessage = document.getElementById(“banner_message”);
    oBannerMessage.innerHTML = “<span class=\”spacer\“>END OF
SCENARIO</span>”;
    oBannerMessage.classList.add(“visible”);
  }
  document.getElementById(“button_choices”).innerHTML = sChoiceHTML;
}
window.addEventListener(‘load’, function(e) {
  generateHTML( );
  displayStepById(“1”);
}, false);
</script>
            <style type=“text/css”>
:root {
--some-variable: 55px;
}
html,body {
width: 100%;
height: 100%;
}
body {
margin: 0px;
font-family: rubikregular;
background: #000;
}
a {
text-decoration: none;
color: #000;
}
.avatar-video-container {
background: #000;
position: relative;
width: 100%;
height: 100%;
}
.avatar-video-container video {
position: absolute;
opacity: 0;
transition: opacity 0.3s;
}
.avatar-video-container video.active-avatar-video {
opacity:1 !important;
}
#button_choices {
position: absolute;
bottom: 0px;
display: block;
width: 100%;
text-align: center;
padding-bottom: 40px;
}
#button_choices a {
display: inline-block;
width: 20%;
margin: 1%;
border: 0px rgba(255,255,255,0.9) solid;
border-radius: 6px;
background: rgba(12,123,198,0.6);
color: #fff;
box-shadow: 0px 3px 8px rgba(0,0,0,0.2);
padding: 1em 3em;
font-family: rubikmedium;
font-size: 120%;
line-height: 150%;
}
#button_choices a:hover {
border: 0px rgba(255,255,255,1) solid;
border-radius: 6px;
background: rgba(12,123,198,0.9);
color: #fff;
box-shadow: 0px 3px 8px rgba(0,0,0,0.6);
}
#banner_message {
position: absolute;
bottom: −105px;
height: 100px;
display: block;
width: 100%;
text-align: center;
background: rgba(255,255,255,0.4);
backdrop-filter: blur(10px);
transition: bottom 0.5s;
font-family: rubikmedium;
font-size:110%;
color:rgba(6,61,99,0.9);
line-height: 150%;
}
#banner_message.visible {
bottom: 0px;
}
#banner_message .spacer {
display: inline-block;
margin-top: 2.1em;
}
</style>
</head>
<body>
<div class=“avatar-video-container”>
  <span id=“avatar_video_container”></span>
  <span id=“button_choices”></span>
  <span id=“banner_message”></span>
</div>
            </body>
```

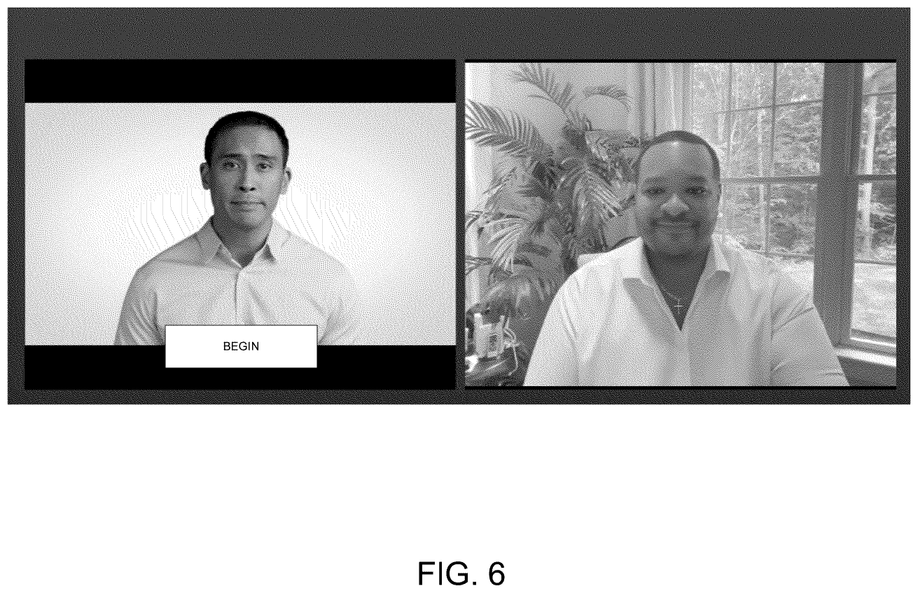

Referring now to FIGS. 6-8, depictions of a virtual respondent, as a video and a human that are in juxtaposition and that are practicing a presentation are shown. In this implementation, the virtual respondent is a computer generated video of a virtual actor that provides responses to the user's narrative in the form of computer generated narrative of the virtual actor. In other implementations, the virtual respondent is depicted only as text-based speech bubbles that show responses to the user's narrative, but without the computer generated actor video or audio or both. Other variations are possible.

FIG. 6 shows an initial screen shot with a “begin” button placed over a portion of the virtual actor. The human uses his mouse to start the presentation by selecting the “begin” button.

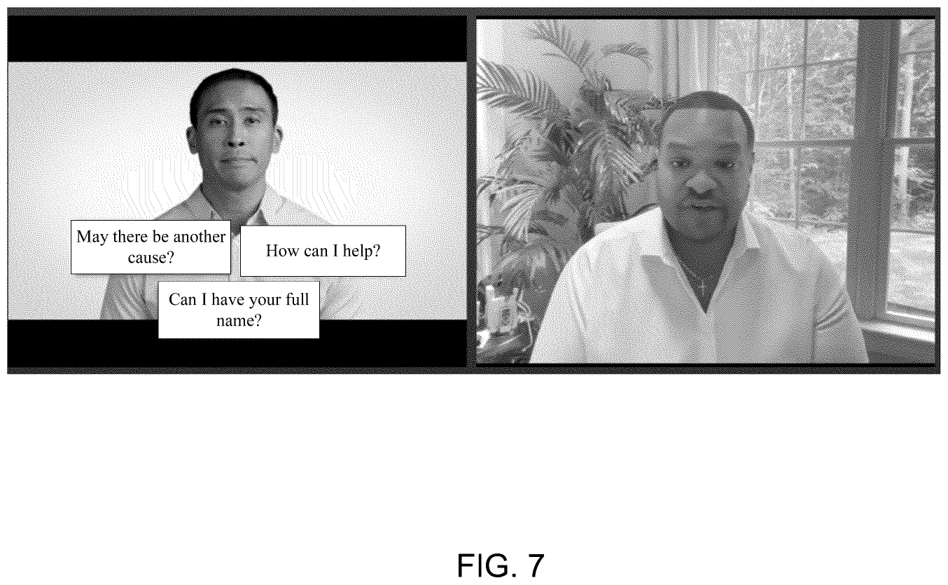

FIG. 7 shows a subsequent screen shot later in the presentation, with a “May there be another cause?,” “How can I help?” and “Can I have your full name?” statements that present choices to the human participant in the form of buttons generated over a portion of the virtual actor.

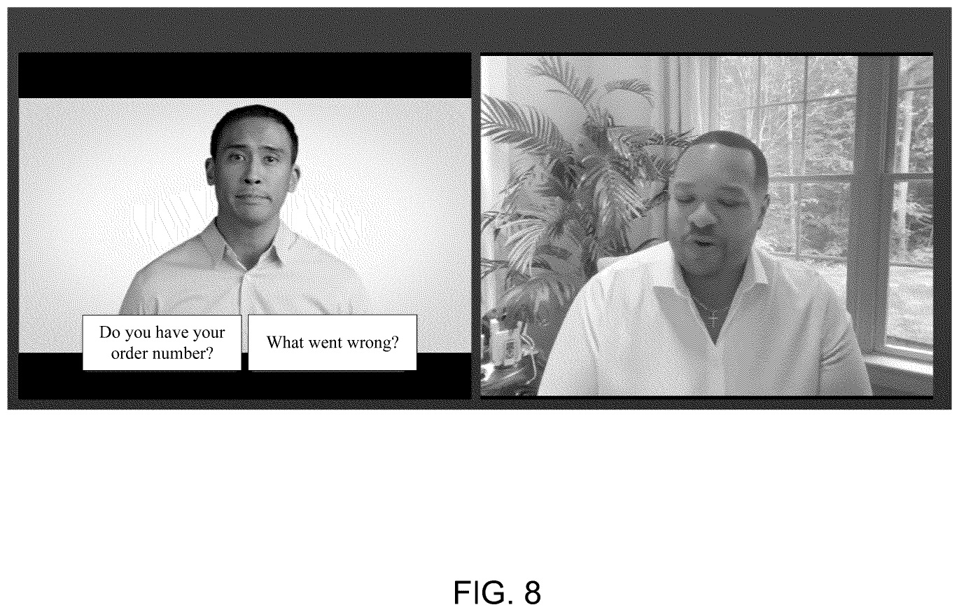

FIG. 8 shows a subsequent screen shot still later in the presentation, with a “Do you have your order number?” and “What went wrong?” statements that present choices to the human participant in the form of buttons generated over a portion of the virtual actor.

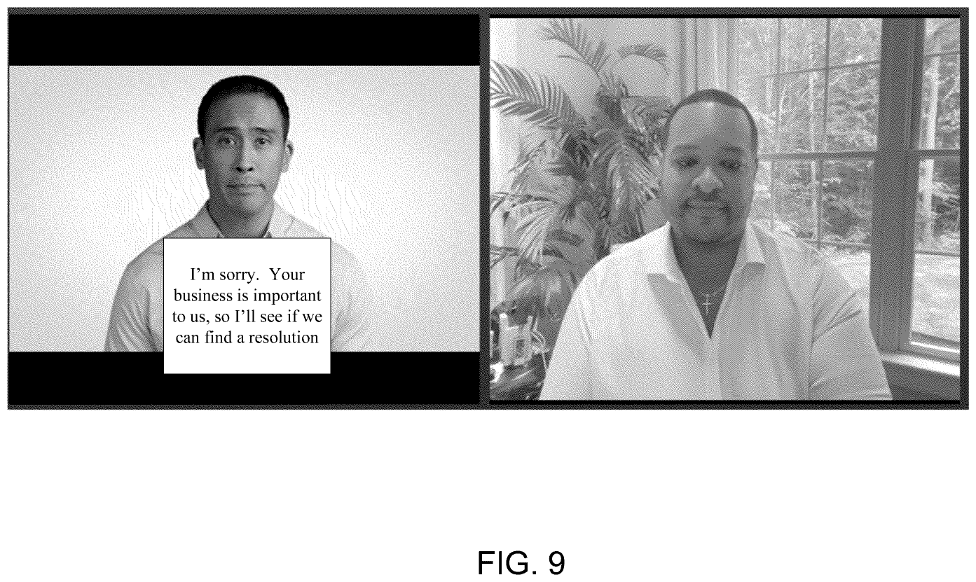

FIG. 9 shows a subsequent screen shot still later in the presentation, with a “I'm sorry. Your business is important to us, so I'll see if we can find a resolution” statement that presents a choice to the human participant in the form of a button generated over a portion of the virtual actor.

An example conversation is shown below in Table 1 through Table 4, which are partitions taken from a master table having the following columns.
Step Number;
VAS;
Choice 1;
Go to 1;
Choice 2;
Go to 2;
Choice 3;
Go to 3;
Choice 4;
Go to 4; and
Notes;
   where “VAS” corresponds to a “Virtual Actor Statement,” there being one video for each virtual actor statement.

Table 1 below shows a step number and a virtual actor statement for a sample conversation simulation script for “Order Not Delivered.” Table 1 also shows the step number and a choice 1 with a go to for choice 1 for the respective virtual actor statements. In Table 1 through Table 4, the choice numbers correspond to different branches for a branching moment from one or more branching moments, e.g., a particular selected branch.

TABLE 1

| Step | | Step | | Go |
|---|---|---|---|---|
| Number | VAS | Number | Choice 1 (human) | to 1 |
| 1 | Hi. Are you with | 1 | Yes. Hello. | 2 |
| | customer service? | | | |
| 2 | I'm having a problem | 2 | Can I have | 2.1 |
| | with an order that I | | your full name? | |
| | placed about one week | | | |
| | ago. I spoke with some- | | | |
| | one named Jane, and | | | |
| | I'm wondering if she | | | |
| | got confused at some | | | |
| | point. | | | |
| 2.1 | Sure. My name is Jack | 2.1 | Do you have | 3.1 |
| | Johnson. J-O-H-N-S- | | your order #? | |
| | O-N. | | | |
| 2.2 | Is there a chance that | 2.2 | Great question. | 4.1 |
| | it shipped to my old | | Let me find out | |
| | address? If that | | right now | |
| | happened, would you be | | | |
| | able to ship a replace- | | | |
| | ment to my correct | | | |
| | address? | | | |
| 2.3 | I don't think so. I've | 2.3 | Let me find a | 4.1 |
| | ordered from you many | | way to help. I | |
| | times. I know how the | | see the order in | |
| | system works. | | the system. | |
| 2.4 | Your website says the | 2.4 | Let me find a | 4.1 |
| | order was delivered, | | way to help. I | |
| | but I haven't received | | see this is order | |
| | anything. I tried calling | | number 397135. | |
| | yesterday, but didn't | | | |
| | have any luck | | | |
| 3.1 | The order number is | 3.1 | I'm sorry. | 4.1 |
| | 3-9-7-1-3-5. I placed | | Your business | |
| | it exactly six days ago. | | is important to | |
| | The site says it was | | us, so I'll see if | |
| | delivered, but I haven't | | we can find a | |
| | received anything. I | | resolution | |
| | tried calling yesterday, | | | |
| | but didn't have any | | | |
| | luck. | | | |
| 3.2 | Are you saying that it's | 3.2 | Not at all. Let | 5.1 |
| | my fault? That's not | | me check on | |
| | very helpful. | | our options | |
| 3.3 | My interactions with | 3.3 | You're right to | 5.1 |
| | your team have really | | expect | |
| | not been pleasant. A | | professionalism | |
| | few felt very | | | |
| | unprofessional. | | | |
| 4.1 | Are you able to get it | 4.1 | I have authori- | 6.1 |
| | to me after all? | | zation, so can I re- | |
| | | | send a new one? | |
| 5.1 | Is there anything that | 5.1 | It looks like I'm | 6.2 |
| | you can do for me | | authorized to re- | |
| | besides talking? | | send a new one, | |
| | Sometimes that just | | just this once. | |
| | feels like companies | | Should I do that? | |
| | offering condolences | | | |
| | and lip service. | | | |
| 5.2 | Look. Can't you just | 5.2 | I'd need approval. | 6.2 |
| | bend the rules? I'd | | Once I receive it | |
| | really hate to have | | I'll update you. | |
| | this problem linger for | | You'll hear back | |
| | another week. | | in 48 hours or less. | |
| 6.1 | I think that's exactly | 6.1 | End | −1 |
| | what I needed. Thank | | | |
| | you so much for your | | | |
| | help today. I'll let you | | | |
| | go, now. Have a great | | | |
| | day! | | | |
| 6.2 | I was worried for a | 6.2 | End | −1 |
| | minute there, but that | | | |
| | sounds perfect. I'll | | | |
| | keep an eye out for it. | | | |
| | Thanks for helping me. | | | |
| 6.3 | That may help a bit. | 6.3 | End | −1 |
| | I'll think about it and | | | |
| | call back before the | | | |
| | end of the week. I | | | |
| | appreciate you trying | | | |
| | to be helpful. | | | |
| 6.4 | This is really frustrating. | 6.4 | End | −1 |
| | I don't feel like we're | | | |
| | getting anywhere. I need | | | |
| | to speak to your | | | |
| | manager, please. | | | |
| 6.5 | I don't have any more | 6.5 | End | −1 |
| | time right now. But I | | | |
| | may call back later this | | | |
| | week. I wish we could | | | |
| | have found a solution. | | | |

Table 2 below shows the step number and a choice 2 with a go to for choice 2 for the respective virtual actor statements from Table 1, above, e.g., to the extent that the branching moments include a second branch. Table 2 also shows the step number and a choice 3 with a go to for choice 3 for the respective virtual actor statements from Table 1, above, e.g., to the extent that the branching moments include a third branch.

TABLE 2

| Step | Choice 2 | | Step | Choice 3 | |
|---|---|---|---|---|---|
| Number | (human) | Go to 2 | Number | (human) | Go to 3 |
| 1 | | | 1 | | |
| 2 | How can I help? | 2.2 | 2 | May there | 2.3 |
| | | | | be another | |
| | | | | cause? | |
| 2.1 | What went wrong? | 2.4 | 2.1 | | |
| 2.2 | I'm not sure I can | 5.2 | 2.2 | | |
| | do something like | | | | |
| | that | | | | |
| 2.3 | That doesn't sound | 3.3 | 2.3 | Are you | 3.2 |
| | likely, though. Are | | | 100% | |
| | you saying Jane was | | | certain? | |
| | mistaken? | | | | |
| 2.4 | Did you look all | 3.2 | 2.4 | | |
| | around your | | | | |
| | property? | | | | |
| 3.1 | | | 3.1 | | |
| 3.2 | I'm just trying to be | 3.3 | 3.2 | | |
| | thorough | | | | |
| 3.3 | I'm very sorry. | 6.4 | 3.3 | I'm not | 6.4 |
| | That must have | | | sure that I | |
| | been upsetting. | | | can help | |
| | | | | you | |
| 4.1 | I may have to | 5.1 | 4.1 | | |
| | investigate more | | | | |
| | before I'll know | | | | |
| 5.1 | Would you like a | 6.3 | 5.1 | I need to | 6.5 |
| | credit for your next | | | transfer | |
| | order? | | | you. Can | |
| | | | | you hold? | |
| 5.2 | That isn't our | 6.4 | 5.2 | I may be | 6.3 |
| | policy. I'm sorry. | | | able to | |
| | Is there another way | | | file a | |
| | that I can help? | | | claim with | |
| | | | | our | |
| | | | | shipping | |
| | | | | vendor. | |
| | | | | Can you | |
| | | | | hold while | |
| | | | | I do that? | |
| 6.1 | | | 6.1 | | |
| 6.2 | | | 6.2 | | |
| 6.3 | | | 6.3 | | |
| 6.4 | | | 6.4 | | |
| 6.5 | | | 6.5 | | |

Table 3 below shows the step number and a choice 4 with a go to for choice 4 for the respective virtual actor statements from Table 1, above, e.g., to the extent that the branching moments include a fourth branch. Table 3 also shows the step number and Notes, if any, indicating a disposition (steps 6.1 through 6.5 of the conversation for the respective virtual actor statements from Table 1, above.)

TABLE 3

| Step | | Go | Step | |
|---|---|---|---|---|
| Number | Choice 4 (human) | to 4 | Number | Notes |
| 1 | | | 1 | Intro |
| 2 | | | 2 | Opening |
| | | | | Statement |
| 2.1 | | | 2.1 | |
| 2.2 | | | 2.2 | |
| 2.3 | | | 2.3 | |
| 2.4 | | | 2.4 | |
| 3.1 | | | 3.1 | |
| 3.2 | | | 3.2 | |
| 3.3 | | | 3.3 | |
| 4.1 | | | 4.1 | |
| 5.1 | | | 5.1 | |
| 5.2 | The best I can do is transfer | 6.5 | 5.2 | |
| | you. Would you like to hold? | | | |
| 6.1 | | | 6.1 | Success |
| | | | | conclusion |
| 6.2 | | | 6.2 | Success |
| | | | | conclusion |
| 6.3 | | | 6.3 | Neutral |
| | | | | conclusion |
| 6.4 | | | 6.4 | Failure |
| | | | | conclusion |
| 6.5 | | | 6.5 | Neutral |
| | | | | conclusion |

Tables 1-3 can be configured to render conversations from very positive to very negative, by selecting different initial starting statements. The script author will have some conversational paths that end well, with a happy customer, and other conversational paths that could end badly, with an irate customer escalating to a manager or hanging up on the rep. The choices that the rep makes along the way determine which path the conversation takes and the resulting outcome at the end.

Table 4 below shows the statements (col. 1), the statements ready to be copied/pasted as JavaScript and the statements ready to be copied/pasted as XML for a Manifest file (only for video).

TABLE 4

| | Ready to use |
|---|---|
| | as XML for |
| Ready to use in JavaScript | Manifest file |
| { | |
| “step_1”: {stepid:“1”, | <file |
| statement:“Hi. Are you with | href=“scormcontent/ |
| customer service?”, | assets/Clip_{—} |
| choice1:{caption:“Yes. | 1.mp4” /> |
| Hello.”,gotoid:“2”} }, | |
| “step_2”: {stepid:“2”, | <file |
| statement:“I'm having a problem | href=“scormcontent/ |
| with an order that I placed about | assets/Clip_{—} |
| one week ago. I spoke with | 2.mp4” /> |
| someone named Jane, and I'm | |
| wondering if she got confused at | |
| some point.”, | |
| choice1:{caption:“Can I have | |
| your full name?”,gotoid:“2.1”}, | |
| choice2:{caption:“How can I | |
| help?”,gotoid:“2.2”}, | |
| choice3:{caption:“May there be | |
| another cause?”,gotoid:“2.3”} }, | |
| “step_2.1”: {stepid:“2.1”, | <file |
| statement:“Sure. My name is | href=“scormcontent/ |
| Jack Johnson. J-O-H-N-S-O-N.”, | assets/Clip_{—} |
| choice1:{caption:“Do you have | 2.1.mp4” /> |
| your order #?”,gotoid:“3.1”}, | |
| choice2:{caption:“What went | |
| wrong?”,gotoid:“2.4”} }, | |
| “step_2.2”: {stepid:“2.2”, | <file |
| statement:“Is there a chance that | href=“scormcontent/ |
| it shipped to my old address? If | assets/Clip_{—} |
| that happened, would you be | 2.2.mp4” /> |
| able to ship a replacement to my | |
| correct address?”, | |
| choice1:{caption:“Great | |
| question. Let me find out right | |
| now”,gotoid:“4.1”}, | |
| choice2:{caption:“I'm not sure I | |
| can do something like | |
| that”,gotoid:“5.2”} }, | |
| “step_2.3”: {stepid:“2.3”, | <file |
| statement:“I don't think so. I've | href=“scormcontent/ |
| ordered from you many times. I | assets/Clip_{—} |
| know how the system works.”, | 2.3.mp4” /> |
| choice1:{caption:“Let me find a | |
| way to help. I see the order in | |
| the system.”,gotoid:“4.1”}, | |
| choice2:{caption:“That doesn't | |
| sound likely, though. Are you | |
| saying Jane was | |
| mistaken?”,gotoid:“3.3”}, | |
| choice3:{caption:“Are you 100% | |
| certain?”,gotoid:“3.2”} }, | |
| “step_2.4”: {stepid:“2.4”, | <file |
| statement:“Your website says the | href=“scormcontent/ |
| order was delivered, but I | assets/Clip_{—} |
| haven't received anything. I tried | 2.4.mp4” /> |
| calling yesterday, but didn't have | |
| any luck”, choice1:{caption:“Let | |
| me find a way to help. I see this | |
| is order number | |
| 397135.”,gotoid:“4.1”}, | |
| choice2:{caption:“Did you look | |
| all around your | |
| property?”,gotoid:“3.2”} }, | |
| “step_3.1”: {stepid:“3.1”, | <file |
| statement:“The order number is | href=“scormcontent/ |
| 3-9-7-1-3-5. I placed it exactly | assets/Clip_{—} |
| six days ago. The site says it was | 3.1.mp4” /> |
| delivered, but I haven't received | |
| anything. I tried calling | |
| yesterday, but didn't have any | |
| luck.”, choice1:{caption:“I'm | |
| sorry. Your business is important | |
| to us, so I'll see if we can find a | |
| resolution”,gotoid:“4.1”} }, | |
| “step_3.2”: {stepid:“3.2”, | <file |
| statement:“Are you saying that | href=“scormcontent/ |
| it's my fault? That's not very | assets/Clip_{—} |
| helpful.”, choice1:{caption:“Not | 3.2.mp4” > |
| at all. Let me check on our | |
| options”,gotoid:“5.1”}, | |
| choice2:{caption:“I'm just trying | |
| to be thorough”,gotoid:“3.3”} }, | |
| “step_3.3”: {stepid:“3.3”, | <file |
| statement:“My interactions with | href=“scormcontent/ |
| your team have really not been | assets/Clip_{—} |
| pleasant. A few felt very | 3.3.mp4” /> |
| unprofessional.”, | |
| choice1:{caption:“You're right | |
| to expect | |
| professionalism”,gotoid:“5.1”}, | |
| choice2:{caption:“I'm very | |
| sorry. That must have been | |
| upsetting.”,gotoid:“6.4”}, | |
| choice3:{caption:“I'm not sure | |
| that I can help | |
| you”,gotoid:“6.4”} }, | |
| “step_4.1”: {stepid:“4.1”, | <file |
| statement:“Are you able to get it | href=“scormcontent/ |
| to me after all?”, | assets/Clip_{—} |
| choice1:{caption:“I have | 4.1.mp4” /> |
| authorization, so can I re-send a | |
| new one? ”,gotoid:“6.1”}, | |
| choice2:{caption:“I may have to | |
| investigate more before I'll | |
| know”,gotoid:“5.1”} }, | |
| “step_5.1”: {stepid:“5.1”, | <file |
| statement:“Is there anything that | href=“scormcontent/ |
| you can do for me besides | assets/Clip_{—} |
| talking? Sometimes that just | 5.1.mp4” /> |
| feels like companies offering | |
| condolences and lip service.”, | |
| choice1:{caption:“It looks like | |
| I'm authorized to re-send a new | |
| one, just this once. Should I do | |
| that?”,gotoid:“6.2”}, | |
| choice2:{caption:“Would you | |
| like a credit for your next | |
| order?”,gotoid:“6.3”}, | |
| choice3:{caption:“I need to | |
| transfer you. Can you | |
| hold?”,gotoid:“6.5”} }, | |
| “step_5.2”: {stepid:“5.2”, | <file |
| statement:“Look. Can't you just | href=“scormcontent/ |
| bend the rules? I'd really hate to | assets/Clip_{—} |
| have this problem linger for | 5.2.mp4” /> |
| another week.”, | |
| choice1:{caption:“I'd need | |
| approval. Once I receive it, I'll | |
| update you. You'll hear back in | |
| 48 hours or less.”,gotoid:“6.2”}, | |
| choice2:{caption:“That isn't our | |
| policy. I'm sorry. Is there another | |
| way that I can | |
| help?”,gotoid:“6.4”}, | |
| choice3:{caption:“I may be able | |
| to file a claim with our shipping | |
| vendor. Can you hold while I do | |
| that?”,gotoid:“6.3”}, | |
| choice4:{caption:“The best I can | |
| do is transfer you. Would you | |
| like to hold?”,gotoid:“6.5”} }, | |
| “step_6.1”: {stepid:“6.1”, | <file |
| statement:“I think that's exactly | href=“scormcontent/ |
| what I needed. Thank you so | assets/Clip_{—} |
| much for your help today. I'll let | 6.1.mp4” /> |
| you go, now. Have a great day!”, | |
| choice1:{caption:“End”,gotoid:“− | |
| 1”} }, | |
| “step_6.2”: {stepid:“6.2”, | <file |
| statement:“I was worried for a | href=“scormcontent/ |
| minute there, but that sounds | assets/Clip_{—} |
| perfect. I'll keep an eye out for it. | 6.2.mp4” /> |
| Thanks for helping me.”, | |
| choice1:{caption:“End”,gotoid:“− | |
| 1”} }, | |
| “step_6.3”: {stepid:“6.3”, | <file |
| statement:“That may help a bit. | href=“scormcontent/ |
| I'll think about it and call back | assets/Clip_{—} |
| before the end of the week. I | 6.3.mp4” /> |
| appreciate you trying to be | |
| helpful.”, | |
| choice1:{caption:“End”,gotoid:“− | |
| 1”} }, | |
| “step_6.4”: {stepid:“6.4”, | <file |
| statement:“This is really | href=“scormcontent/ |
| frustrating. I don't feel like we're | assets/Clip_{—} |
| getting anywhere. I need to | 6.4.mp4” /> |
| speak to your manager, please.”, | |
| choice1:{caption:“End”,gotoid:“− | |
| 1”} }, | |
| “step_6.5”: {stepid:“6.5”, | <file |
| statement:“I don't have any more | href=“scormcontent/ |
| time right now. But I may call | assets/Clip_{—} |
| back later this week. I wish we | 6.5.mp4” /> |
| could have found a solution.”, | |
| choice1:{caption:“End”,gotoid:“− | |
| 1”} }, | |
| } | |

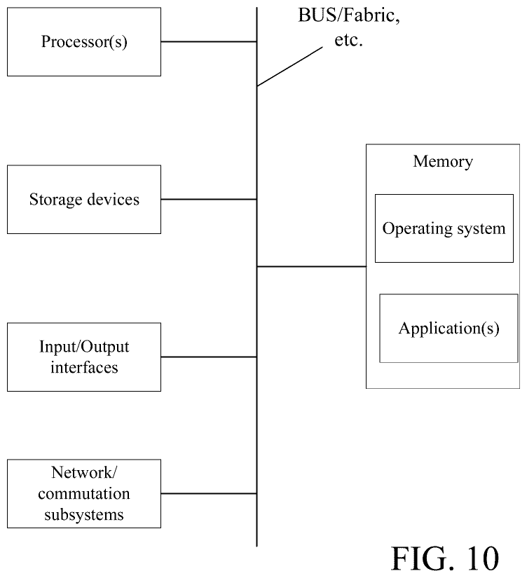

As shown in FIG. 10, the essential elements of a computer are one or more programmable processors for performing actions in accordance with instructions and one or more memory devices for storing instructions and data. Generally, a computer will also include, or be operatively coupled, (via bus, fabric, network, etc.) to I/O interfaces, network/communication subsystems, and one or more mass storage devices for storing data (e.g., magnetic, magneto optical disks, or optical disks).

Embodiments can be implemented in digital electronic circuitry, or in computer hardware, firmware, software, or in combinations thereof. Embodiments can be implemented in a computer program product tangibly stored in a machine-readable (e.g., computer readable) hardware storage device for execution by a programmable processor; and method actions can be performed by a programmable processor executing a program of executable computer code (executable computer instructions) to perform functions of the invention by operating on input data and generating output. Embodiments can be implemented advantageously in one or more computer programs executable on a programmable system, such as a data processing system that includes at least one programmable processor coupled to receive data and executable computer code from, and to transmit data and executable computer code to, memory, and a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive executable computer code and data from memory, e.g., a read-only memory and/or a random access memory and/or other hardware storage devices. Generally, a computer will include one or more mass storage devices for storing data files; such devices include magnetic disks, such as internal hard disks and removable disks; magneto-optical disks; and optical disks. Hardware storage devices suitable for tangibly storing computer program executable computer code and data include all forms of volatile memory, e.g., semiconductor random access memory (RAM), all forms of non-volatile memory including, by way of example, semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

A number of embodiments of the invention have been described. The embodiments can be put to various uses, such as educational, job performance enhancement, e.g., sales force and so forth. Nevertheless, it will be understood that various modifications may be made without departing from the scope of the invention.

What is claimed is:

1. A computer-implemented method comprises:
receiving, by a computer, a text string having one or more branching moments, with the computer including a processor, memory, a non-transitory computer storage, and input/output devices;
processing, by the computer, the text string to recognize indications of the one or more branching moments given the text string;
converting, by the computer, the processed text string and the indications of the one or more branching moments into executable computer code;
receiving, by the computer, a response to a given one of the converted one or more branching moments from a predetermined set of responses;
generating, by the computer from the executable computer code and media elements for the response, a virtual respondent; and
storing, by the computer, the executable computer code and the media elements as a file in the computer storage that represents the virtual respondent.

2. The method of claim 1 further comprises:
executing the executable computer code to render the response to the text string at the one or more branching moments into computer generated audio; and
sending the computer generated audio to a client device to cause the client device to present the computer generated audio at the one or more branching moments.

3. The method of claim 1 further comprises:
generating, from the executable computer code and the media elements, a virtual actor; and
causing the virtual actor to render a selected response.

4. The method of claim 1 further comprises:
pausing video of the virtual respondent;
causing choice buttons, for the given one of the converted one or more branching moments, to be rendered in juxtaposition to the paused video of the virtual respondent; and
receiving input indicating selection of one of the choice buttons which selection indicates the response.

5. The method of claim 1 further comprises:
generating a series of text only written responses; and
causing the series of text only written responses to be rendered for a selected response.

6. The method of claim 1 further comprises:
receiving an audio signal encoding speech from a participant operating a client device; and
converting the received audio signal into the text string.

7. The method of claim 6, wherein the client device comprises a separate device from the computer.

8. The method of claim 1, wherein:
processing the text string to recognize indications of the one or more branching moments given the text string comprises detecting, in the text string, the one or more branching moments;
converting the processed text string comprises converting the processed text string and the indications of the one or more branching moments into JavaScript Object Notation (JSON); and
generating, using the JSON and the media elements, the virtual respondent comprises generating one or more files that reference the JSON and the media elements.

9. A data processing system comprising:
one or more processor devices and memory in communication with the one or more processor devices, with the one or more processor devices and the memory configured by executable computer code to cause the data processing system to perform operations comprising:
receiving a text string having one or more branching moments;
processing the text string to recognize indications of the one or more branching moments given the text string;
converting the processed text string and the indications of the one or more branching moments into executable computer code;
receiving a response to a given one of the converted one or more branching moments from a predetermined set of responses;
generating, from the executable computer code and media elements for the response, a virtual respondent; and
storing the executable computer code and the media elements as a file in a computer storage that represents the virtual respondent.

10. The system of claim 9 the operations further comprising:
executing the executable computer code to render the response to the text string at the one or more branching moments into computer generated audio; and
sending the computer generated audio to a client device to cause the client device to present the computer generated audio at the one or more branching moments.

11. The system of claim 9 the operations further comprising:
generating, from the executable computer code and the media elements, a virtual actor; and
causing the virtual actor to render a selected response.

12. The system of claim 9 the operations further comprising:
pausing video of the virtual respondent;
causing choice buttons, for the given one of the converted one or more branching moments, to be rendered in juxtaposition to the paused video of the virtual respondent; and
receiving input indicating selection of one of the choice buttons which selection indicates the response.

13. The system of claim 9 the operations further comprising:
generating a series of text only written responses; and
causing the series of text only written responses to be rendered for a selected response.

14. The system of claim 9 the operations further comprising:
receiving an audio signal encoding speech from a participant operating a client device; and
converting the received audio signal into the text string.

15. The system of claim 14, wherein the client device comprises a separate device from the system.

16. The system of claim 9, wherein:
processing the text string to recognize indications of the one or more branching moments given the text string comprises detecting, in the text string, the one or more branching moments;
converting the processed text string comprises converting the processed text string and the indications of the one or more branching moments into JavaScript Object Notation (JSON); and
generating, using the JSON and the media elements, the virtual respondent comprises generating one or more files that reference the JSON and the media elements.

17. A computer program product tangibly storing a computer program on one or more non-transitory computer readable media, the computer program comprising executable code to cause a data processing system that includes one or more processor devices and memory in communication with the one or more processor devices to perform operations comprising:
receiving a text string having one or more branching moments;
processing the text string to recognize indications of the one or more branching moments given the text string;
converting the processed text string and the indications of the one or more branching moments into executable computer code;
receiving a response to a given one of the converted one or more branching moments from a predetermined set of responses;
generating, from the executable computer code and media elements for the response, a virtual respondent; and
storing the executable computer code and the media elements as a file in a computer storage that represents the virtual respondent.

18. The computer program product of claim 17 the operations further comprising:
executing the executable computer code to render the response to the text string at the one or more branching moments into computer generated audio; and
sending the computer generated audio to a client device to cause the client device to present the computer generated audio at the one or more branching moments.

19. The computer program product of claim 17 the operations further comprising:
generating, from the executable computer code and the media elements, a virtual actor; and
causing the virtual actor to render a selected response.

20. The computer program product of claim 17 the operations further comprising:
pausing video of the virtual respondent;
causing choice buttons, for the given one of the converted one or more branching moments, to be rendered in juxtaposition to the paused video of the virtual respondent; and
receiving input indicating selection of one of the choice buttons which selection indicates the response.
